(19) United States
(12) Patent Application Publication
(10) Pub. No.: US 2005/0051640 A1
(43) Pub. Date: Mar. 10, 2005

(54) Attachment for flushing water and debris from and enabling servicing of a sprinkler head

(76) Inventor: Theodore Sirkin, Woodland Hills, CA (US)

Correspondence Address: ROBERT J. SCHAAP;Suite 188, 21241 Ventura Boulevard, Woodland Hills, CA, 91364, US

(21) Appl. No.: 10/656,547

(22) Filed: Sep. 4, 2003

(51) Int. Cl. B05B 1/28

(52) U.S. Cl. 239/104

(57) ABSTRACT

An attachment to a sprinkler head allowing for the flushing of water and debris from the sprinkler head after servicing thereof, without saturating the site of the sprinkler head with the flushed water. The device comprises a body having a first arm directing water generally upwardly from the sprinkler head, and a second arm for directing water away from the site of the sprinkler head. A third arm is provided for engagement by a user to facilitate connecting and disconnecting of the attachment to the sprinkler head.

### BACKGROUND OF THE INVENTION

1. Field of the Invention

This invention relates in general to certain new and useful improvements in temporary attachments for sprinkler heads that allow for flushing of water and debris from the sprinkler head, primarily in the maintenance thereof. This invention relates, more particularly, to an attachment of the type stated, which contains internal ducts for allowing water flow therethrough to control the direction of water away from the site of the sprinkler head to a desired location, or to merely flush a sprinkler head without redirection of water.

2. Brief Description of Related Art

All lawn sprinkler heads are constructed either of metal materials or plastics, such as ABS, or like moldable plastics. All spray type sprinkler heads, particularly lawn and garden sprinkler heads, are of the stationary or of the pop-up type. They are made, at least, of a two-piece construction, including a base or body along with an insert or nozzle which is threadedly mounted on the upper end of the base. In this way, the insert can be threadedly removed from the base to facilitate cleaning or adjustment.

“Pop-up” sprinkler heads, that is, sprinkler heads which have a riser stem capable of shifting upwardly out of the sprinkler head housing, carry a nozzle at an upper end thereof. However, all sprinkler heads will generally comprise at least a body or housing along with an insert or nozzle that allow for distribution of water to a ground surface. For pop-up type sprinkler heads the nozzle is generally threadedly mounted at the upper end of the riser stem which rests within the housing when not in use. On stationary heads, the nozzle is threadedly attached to the sprinkler head body, commonly referred to in the industry as a “shrub body”. Although the terms “body” and “housing” are sometimes used to refer to different types of sprinkler heads, the terms “body” and “housing” will be used interchangeably herein.

Further, all spray-type sprinkler head nozzles manufactured for distribution on the North American continent are now standardized, carrying a male thread for attachment to a female-threaded shrub body or pop-up riser stem, or carrying a female thread for attachment to a male-threaded body or riser stem. For example, every manufacturer's female threaded nozzles can be threaded onto any other manufacturer's male shrub bodies or pop-up riser stems.

Sprinkler heads frequently require cleaning and/or adjustment. Oftentimes, debris is carried in the municipal water supply to subterranean pipes and to the sprinkler head. This debris, such as dirt particles and the like may arise from installation of the sprinkler heads, from servicing and repair of the sprinkler system at an upstream location or enters the orifice of the nozzle from the surrounding soil or turf. This debris inevitably enters into the sprinkler head and clogs the insert, precluding proper water flow. As a result, it is necessary to frequently remove the debris from the sprinkler head or, at least, from the orifice thereof.

It is well established that the debris which clogs the sprinkler head will be followed by other debris which may be located in an upstream position in the water supply line. As a result, it is known that after removal of the insert, it is always necessary to turn on the water supply sufficiently to flush the system, in order to remove that extra debris. Otherwise, re-cleaning would have to be accomplished within a short period of time.

When cleaning a stationary sprinkler head, and in order to enable a flushing operation to occur, the service personnel will remove the insert, flush water under pressure through the body of the sprinkler head, as previously described, and adjust or replace the insert as may be required.

In the case of pop-up sprinkler heads, the pop-up riser stem forming part of that head can, with various degrees of difficulty, be manually grasped and pulled up to an extended position in order to remove the nozzle. In this way, the water under pressure is flushed through the pop-up riser, thereby clearing any debris. With a pop-up sprinkler head, once the water is turned off, the pop-up riser will be spring-biased to return to a position hidden within the sprinkler head housing which brings the nozzle area back to the same level as the surrounding soil. Therefore, if the nozzle has been removed, it is important to insure that water, which is already entrained with debris or other water surrounding the vicinity of the sprinkler head and which is mixed with dirt and stones, does not fall back into the pop-up riser itself. The particle entrained water, or so-called “foul” water, will again cause an almost certain need for re-servicing of that particular sprinkler head.

In either case, while the insert is removed, the service personnel will turn the water on, generally at full force, to force out any debris hung up in the sprinkler head body or pop-up riser stem as well as any debris residing in the subterranean sprinkler line supply pipes. Except under the occasional condition of torquing down the sprinkler valve that controls that particular system of heads, without the nozzle in place, the water will exit the head at full force.

With either type of sprinkler head, the nozzle can sometimes be removed while the water is running but the service personnel will certainly receive a drenching and the filter screen under the nozzle will be propelled a lengthy distance and may be irretrievable. But, in any case, the water to the system must almost always be turned off to replace the filter screen and/or nozzle. In general, today's present methods usually result in service personnel getting wet while servicing sprinkler systems of which most of the soaking occurs during the flushing operation.

Other problems relating to the cleaning of sprinkler heads result because of the large quantity of water that rapidly exits the body of the sprinkler head when the nozzle has been removed. This water normally shoots straight up into the air and falls back to the ground surface, right in the vicinity of the sprinkler head being serviced. As a result, the water saturation would interfere with further servicing of that particular sprinkler head. Oftentimes, nearby adjacent areas become saturated and muddy, or the water and debris will splash on pedestrian walkways or cars. Consequently, it would be desirable to divert the water which is being used for flushing away from the site of that particular sprinkler head, and direct it so the water is contained in the planted area, but away from the sprinkler head and out of the way of passers-by.

Essentially all lawn and garden sprinkler heads are devoid of any control valve at the sprinkler head that allows for turning off water flow at that particular sprinkler head. However and more specifically, when an individual control valve is not provided at a sprinkler head, the turning on of water with a full force usually creates a substantial water stream, and while desirable for flushing sprinkler heads, the excess water creates a disposal problem and oftentimes creates a hazard. Very often, the water will collect on walkways or in other areas in which water flow or placement should be avoided.

Another problem facing maintenance and service personnel, particularly with pop-up sprinkler heads, in the absence of a resistance factor which occurs when the nozzle is removed, the pop-up riser does not lift to a raised position by turning on the water and the spring loaded pop-up riser stem simply remains either partially or completely in the housing. As a result, any flushing of a pop-up sprinkler head is difficult without the aid of another person or a vice grips-like tool to keep the riser stem extended.

It would be desirable to provide some means of allowing for flushing of a sprinkler head and diverting the flushed water through that sprinkler to a desired location. At the same time, it would also be desirable to provide a device to restrain a pop-up riser stem from snapping back into the housing of a pop-up sprinkler head during maintenance or servicing thereof without causing damage to the riser stem. Also, at this same time, incorporating into such device a screwdriver head for adjusting the tiny screw atop most plastic nozzles would make the device even more useful. In addition, it may be desirable, under certain conditions, to be able to control the flow of water being flushed out of the head and through the device.

### OBJECTS OF THE INVENTION

It is, therefore, a primary object of the present invention to provide a sprinkler head flushing means which allows for water under pressure to be flushed through a sprinkler head and directed away from the site of the sprinkler head.

It is another object of the present invention to provide an attachment for a sprinkler head, which allows for water passing through the sprinkler head to be directed upwardly and away from the site of the sprinkler head, to avoid ground saturation in the immediate vicinity of the sprinkler head.

It is an additional object of the present invention to provide an attachment for a sprinkler head, regardless of whether or not the head is of the stationary type or the pop-up type. This attachment has threaded ends adapted for connection to the sprinkler head, either with male or female fittings therefor. Thus, the attachment may be provided with male threadings adapted for connection to female threadings on a sprinkler head and the attachment is also provided with female threadings for connection to male threadings on a sprinkler head.

It is also an object of the present invention to provide an attachment for a sprinkler head having a pop-up riser stem which provides for immediate recovery and access to the retracted riser stem or will hold the stem in an extended position, even in the absence of water pressure therefor, and which thereby allows for easy and convenient cleaning of a pop-up sprinkler head body.

It is still a further object of the present invention to provide an attachment for a sprinkler head which can be made in a variety of forms, and all of which are essentially simple in construction but highly effective in operation, and which are also relatively inexpensive to manufacture.

It is another salient object of the present invention to provide a method for allowing water from a ground water supply line to be flushed through the body of a sprinkler head, and up and away from the site of the sprinkler head without substantial ground saturation around the head with the flushing water.

It is yet another object of the present invention to provide an attachment for use with a pop-up sprinkler head, which allows for particle entrained water to be flushed through the sprinkler head under pressure, while the pop-up stem thereof is mechanically held in an extended or retrievable position.

It is yet another object of the invention to be able to attach various items to the attachment, such as threaded fittings or hoses.

It is also an object of the invention to be able to optionally incorporate a mechanism for manually controlling the flow through the attachment for various purposes including water conservation.

It is another object of the invention to have the optional ability to incorporate a tool head for adjusting the sprinkler head and/or other tools desired by the service person.

With the above and other objects in view, my invention resides in the novel features of form, construction, arrangement and combination of parts and components presently described and pointed out in the claims.

### BRIEF SUMMARY OF THE INVENTION

An attachment for a water sprinkler head which may be of a stationary type or a pop-up type and which carries either a male or female nozzle. The attachment may be described in its simplest form as an elbow which is adapted for attachment to an upper end of the body of the sprinkler head, after the insert or nozzle therefor has been removed. The arrangement then allows for water from a subterranean water supply line to be delivered to the sprinkler head body under pressure, allowing for the water to flush debris from the body of the sprinkler head, and any debris which may be contained in the line, outwardly from the upper end of the sprinkler head body. The elbow thereby provides for directional flow of the water away from the site of the sprinkler head. This construction thereby avoids water saturation of the ground surface in the vicinity of the sprinkler head, and allows for directing the water away from non-planted areas.

In actual modes of construction, the attachment comprises a body having a first arm with a duct extending therethrough to direct water and the debris carried in that water stream in a generally upward direction, to allow for any flushing of the sprinkler head. A second arm, also having a duct extending therethrough, is connected to the first arm to allow for redirection of the water, and also any debris carried therewith, away from the site of the sprinkler head. This attachment may also include an outwardly extending third arm which can be manually engaged by a user of the attachment to facilitate connection and disconnection of the attachment to the nozzleless sprinkler head. In this way, manual dexterity is made easier providing quick and convenient attachment to and from a nozzleless sprinkler head.

In a more preferred embodiment, the second arm is located angularly away from the first arm for the redirection of the water flow therefrom. As an example, the second arm may be located at a direction of approximately 90° with respect to the first arm.

The ducts in each of the first and second arms are obviously in fluid communication with one another, and preferably have similar diameters. Moreover, they preferably have similar diameters to the outlet at the upper end of the sprinkler head body, so as to allow for a continuous and smooth water flow directly through the body of the sprinkler head and outwardly of the attachment.

In a more preferred embodiment, the device of the invention is provided with four arms, so that they are essentially located in the shape of a cross. In this way, connection to and removal from the sprinkler head body is further facilitated.

Generally, all sprinkler head bodies and pop-up riser stems are provided with threads on the upper end to receive and allow for removal of the sprinkler head nozzle. After the removal of the nozzle, the attachment of the invention can be connected directly to the upper end of the sprinkler head body or riser stem. Although the thread size at the upper end of the body or stem is now fairly standard, some manufacturers provide female threads at the upper end, and others provide male threads. In order to accommodate this arrangement, one of the multi-arm constructions of the attachment includes a set of male threads on one of the arms, and a set of female threads on the other of the arms. The preferred placement of these two threaded arms in the cross embodiment of the invention is perpendicular to each other. These two arms will each provide for attachment to the shrub body or pop-up riser stem of the sprinkler spray head regardless of the gender of the nozzle. When either of the two arms is attached to a spray head, the other is used to direct the water flow away from the sprinkler head.

In a preferred embodiment of the invention, a four arm construction or so-called “cross” construction, two of the arms may not have a duct, but will be effective for purposes of facilitating connection and removal of the attachment from the sprinkler head body by contributing to balancing the attachment when in the upright position through a more even weight distribution.

Also in a more preferred embodiment, the third arm is located in a direction generally parallel to one of the first and second arms, and generally perpendicular to the other of the first and second arms. The fourth arm is located in a direction generally parallel to one of the second and third arms, and generally perpendicular to the other of the second and third arms.

The ends of certain of the arms carrying the flushing water therethrough also may be externally threaded to allow for an extension pipe to be connected thereto. In this way, the size of the attachment can be extended and the extension thereof can easily be removed. The ends of any of the arms could be constructed so that a garden hose may also be connected thereto.

The attachment of the present invention is generally designed for use with limited area water sprinkler heads, that is, typically lawn and garden type sprinkler heads, and not generally for use with large areas, such as farm sized sprinkler heads, municipal park sprinkler heads, and other areas where impact heads and rotor heads are usually installed. Thus, the attachment is effective with sprinkler heads which are classified as spray heads, and which include, for example, most sprinkler heads that attach to a half-inch diameter riser pipe.

These sprinkler heads have either a riser stem that extends upwardly above the ground surface, and is contained in a larger housing, or a fixed body, which is generally attached to a fixed pipe and is usually located above the nearby shrubbery. In this way, the nozzle or insert is allowed to direct water in selected directions over the ground surface. Moreover, the spray type heads allow for easy removal of the insert therefrom.

The attachment of the invention is generally effective in that it not only allows for water to be redirected away from the site of the sprinkler head, but it also allows for the flushing water to be directed to a selected area. Thus, by pointing the second arm to a specific spot where the flushing water will not interfere with pedestrian traffic or other activity, the water can then be allowed to drain.

A small control valve of the type described in my co-pending U.S. Pat. No. 6,568,608 B2, dated May 27, 2003, may be installed into one of the arms through which water is flushed. In this way, a method to conserve water is available and water spillage can be reduced.

The attachment of the invention also is effective at holding a pop-up riser stem out of the body of the sprinkler head, even when water pressure is turned off. For this purpose, the attachment of the invention can be provided with threads for connection to the pop-up stem, and thereby allow for extension of the pop-up stem out of the body of the sprinkler head. Flushing water can be passed through the attachment whether or not the pop-up stem is fully extended, and thereby thoroughly clean the body of the sprinkler head and the lateral lines underneath. In this manner, after the foul water is ejected, it is precluded from reentering into the body of the sprinkler head.

The attachment of the invention also is effective at providing quick retrieval of the pop-up riser stem after the nozzle has been removed. Normally to remove the nozzle the water must be turned off. With no water pressure pushing upwards on the riser stem, the stem is spring-biased to stay depressed within the housing.

In most cases, the top of the pop-up sprinkler head cap is level with the surrounding soil. Without the nozzle threaded onto the riser stem, the top of the stem normally sits about an inch below the top of the cap inside the housing. This makes retrieval of the riser stem extremely difficult in order to reconnect the nozzle. The attachment of the invention when threaded onto the riser stem makes the riser stem immediately available to pull up from the housing and re-install the nozzle to it.

The remaining two arms of the attachment which are not used for connection to sprinkler heads can also serve utilitarian purposes. For example, tools and the like can be fixed to the outer ends of the remaining two arms of a cross arrangement. A preferred attachment to one of the arms of the device would be a screwdriver head allowing for operating the little flow-control screw atop most plastic sprinkler head nozzles. Another arm could house a tool for similar or other operations.

The attachment of the invention provides numerous advantages to service personnel who operate and service water sprinkler systems. It can be constructed at a relatively low cost, since it can easily be fabricated from metals or plastics or like materials, in low cost forming operations.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a side elevational view of an attachment for use with a sprinkler head for flushing water away from the site of a sprinkler head, in accordance with the present invention;

FIG. 2A is an exploded side elevational view showing the attachment for connection to a sprinkler head;

FIG. 2B is a partial schematic side elevational view showing the attachment of the present invention connected to a sprinkler head, and showing the directing of water away from the site of the sprinkler head;

FIG. 3 is a side elevational view of a sprinkler head mounted in a position within the ground, and showing the insert thereof partially removed;

FIG. 4 is an exploded side elevational view, partially in section, and showing the attachment of the invention in relation to the upper end of a sprinkler head body;

FIG. 5 is an exploded plan view showing an attachment of the invention in spaced relation to the upper end of a pop-up sprinkler riser stem forming part of a pop-up sprinkler head;

FIG. 6 is a plan view showing an attachment of the invention connected to a pop-up sprinkler head of FIG. 5, with the pop-up shaft thereof extended;

FIG. 7 is an exploded plan view showing a modified form of attachment in the shape of a cross having four arms, with a threaded fitting to be connected thereto and which fitting is then connected to an extension pipe;

FIG. 8 is a plan view, similar to FIG. 7, and showing a modified form of a four-armed attachment, in accordance with the present invention, adapted for a hose to be connected thereto;

FIG. 9 is a plan view of another modified form of a four-armed attachment, in accordance with the present invention, which is similar to FIG. 7 but using PVC slip couplings thereon for connection to an extension pipe;

FIG. 10 is a side elevational view of a further modified form of attachment for use with the present invention, primarily adapted for use with pop-up sprinkler heads; and

FIG. 11 is a side elevational view of still a further modified form of attachment for use with the present invention with a tool head incorporated into one arm, a flow-control mechanism into another arm, and a pocket to house the tool that operates the flow-control mechanism in yet another arm.

### DETAILED DESCRIPTION OF PREFERRED EMBODIMENTS

Referring now in more detail and by reference characters to the drawings, which illustrate several preferred embodiments of the present invention, A₁ through A₆ designates various embodiments of attachments for diverting flushing water, and any debris carried therewith, from a sprinkler head SS, for stationary heads, and PS for pop-up sprinklers.

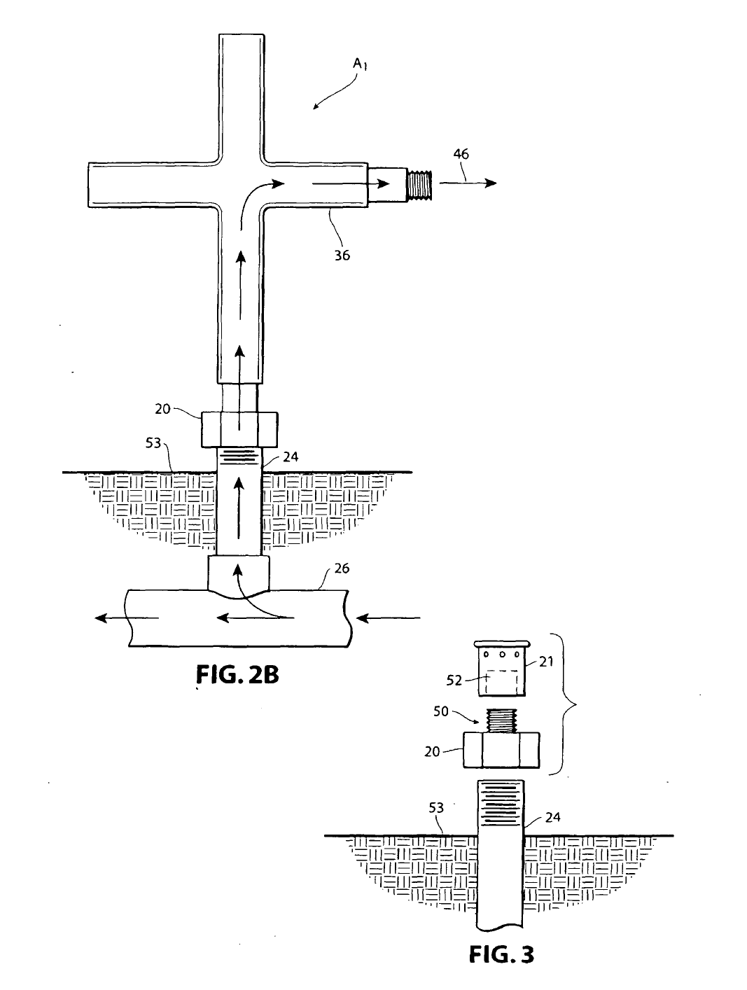

In a more preferred embodiment of the invention, and by reference to FIGS. 2A and 2B, the sprinkler head SS with which the attachment A₁ is used, is generally of a conventional construction, and comprises a body 20 having a lower end 22 connected to a vertically arranged supply line 24, and which receives water under pressure from a water delivery line 26. In accordance with the above-identified construction, it can be observed that the sprinkler head body 20 would be located above the ground surface 53 if the sprinkler were of the shrub head type. The body carries an upper member 21 which is referred to as the nozzle.

In another type of sprinkler head, there is a housing generally at the ground level as shown in FIG. 5. Moreover, the sprinkler head PS includes a pop-up mechanism within the housing that operates in conjunction with a spring (not shown) biased pop-up stem 60, and the latter of which allows for connection of a spray-emitting nozzle (not shown) at its upper end 66. This type of sprinkler is typically referred to as a “pop-up” sprinkler head. As indicated previously, for purposes of the present invention, the housing of the sprinkler head may be referred to as a body or a housing regardless of the type of sprinkler head in which employed.

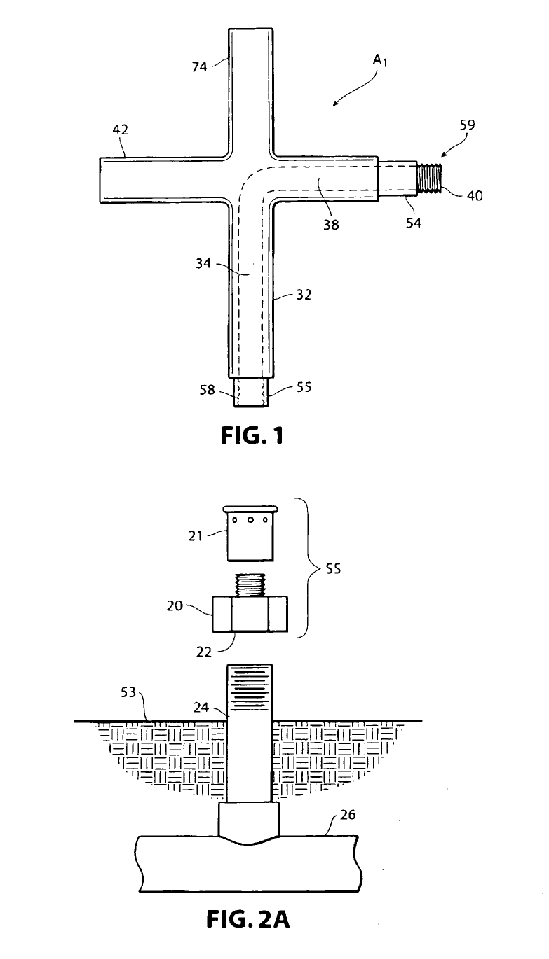

The attachments A₁ to A₄ of the present invention, are preferred embodiments and are in the shape of a cross. In accordance with FIGS. 1 and 2B, it can be observed that when the attachment A₁ is connected to the upper end of the sprinkler head body 20, water will pass through the ducts 34 and 38 of the attachment and out of the open end 40 of the arm 36. In this way, water stream 46 will be directed away from the site of the sprinkler head SS itself. Thus, water will not saturate that area adjacent to the sprinkler head or the service personnel.

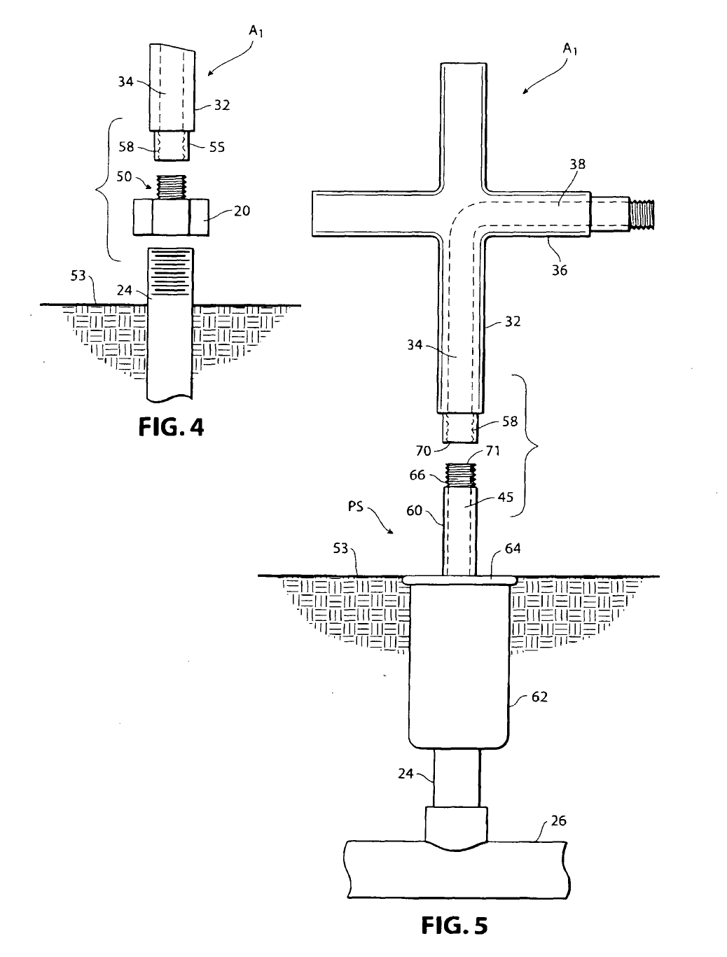

Essentially all sprinkler head bodies 20 are provided at their upper end with a threaded section for attachment of the nozzle 21 as shown in FIG. 2A in conjunction with FIG. 3. The threaded section may be an internally threaded section, such as a female threaded section, or otherwise, it may be externally threaded, such as a male threaded section 50 as shown in FIG. 3. In this case and for explanation purposes only, by reference to FIG. 3, the sprinkler head body 20 is provided at its upper end with an externally threaded section or so-called male threaded section 50, adapted for engagement with an internally threaded section 52 of a nozzle 21. Thus, when the nozzle 21 is removed and the attachment A₁ is to be connected to the sprinkler head body 20, arm 32 of the attachment A₁ is provided with an internally threaded section 58, for engagement with the externally threaded section 50 of the sprinkler head body, as shown in FIG. 4. Alternately, if the sprinkler head body 20 had an internally threaded section, the arm 36 of the attachment A₁ with an externally threaded section is then used for connection to the sprinkler head body.

Inasmuch as thread size on the vast majority of sprinkler heads is now generally consistent, regardless of the manufacturer, the attachment can be provided with a male threaded section 50 and a female threaded section, and thereby enable attachment to all of the present commercially available sprinkler head bodies constructed of a plastic material.

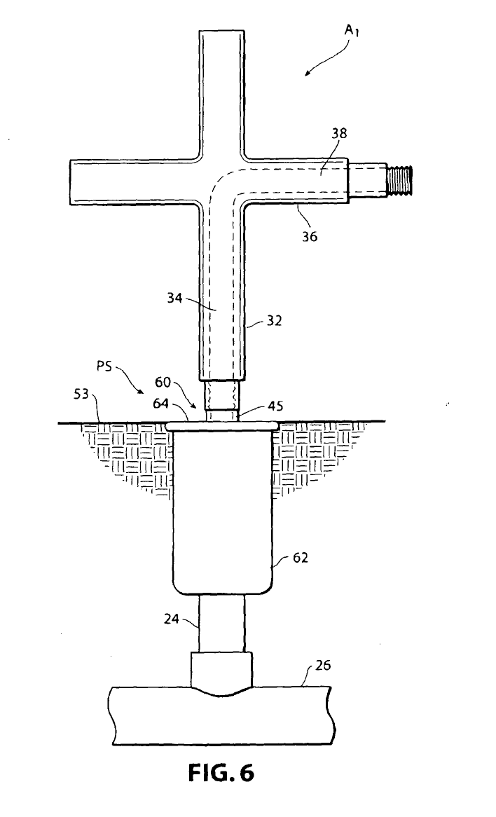

FIGS. 5 and 6 illustrate the invention as being effective for holding a pop-up riser stem 60, of a pop-up sprinkler head PS, in an extended position or allowing for easy retrievability. In this case, a pop-up riser stem 60 is shown as being extended upwardly and outwardly of the housing 62 of the sprinkler head PS against the action of a tension spring (not shown) in the body. Moreover, it is threadedly connected to the lower end 70 of the attachment A₁, in accordance with the present invention. In this case, a pop-up riser stem 60 has an externally threaded section 66, mating with an internally threaded section 58 on the attachment.

For the attachment to be of use with pop-up sprinkler heads, the ends 54 and 55 of arms 32 and 36 (FIGS. 1 and 4) must be of the same approximate diameter as the pop-up riser stem 60 (FIG. 5) in order to pass through the hole in the pop-up sprinkler head cap 64 (FIG. 6) through which the pop-up riser stem 60 extends. As shown in FIGS. 5 and 6, the attachment can be connected to the top of the riser stem after removal of the nozzle. This is applicable even when the stem has retreated back into the pop-up housing, which, because of the spring bias, it will do the moment the service personnel lets go of the extended riser stem.

At the lower end 70 of the attachment A₁, the threads 58 can engage the threads 66 at the upper end 71 of the pop-up riser stem 60, as shown in FIG. 5. In this way, the pop-up riser stem 60 can be held in an extended position or can easily be retrieved if it is allowed to drop back into the housing 62. The end of the pop-up riser stem 60 would extend sufficiently inwardly into the duct 34 of the attachment A₁, so that the pop-up riser stem 60 and the attachment A₁ would be threaded together. In this way, the duct 45 of the pop-up riser stem 60 and the duct 34 of the attachment A₁ would be conjoined and in fluid communication with each other, as shown in FIG. 6. This would allow for effective cleaning or servicing of the sprinkler head.

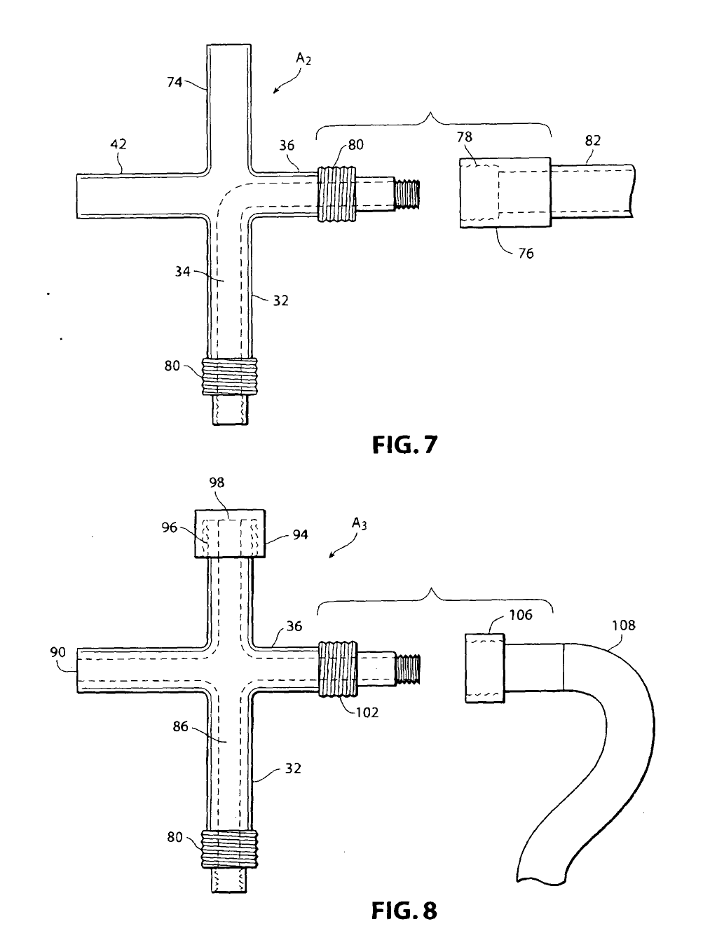

FIG. 7 illustrates another embodiment of the attachment that is also in the shape of a cross. In this respect, the attachment A₂ is similar to the attachment A₁ of FIG. 1, and includes the arms 32, 36, 42 and 74. In addition, this embodiment of the attachment includes the providing of the arms 32 and 36 with externally threaded sections 80, generally in accordance with national IPT standards.

In this way, a fitting 76, such as a standard coupling with ¾″ IPT internal threads 78 can be connected to the external threads 80 allowing for additional extension piping 82 to be joined to the arms 32 or 36 for remote discharge of the water being flushed through duct 34.

The embodiment of the invention, as illustrated in FIG. 7, illustrates wide versatility of the invention. It is effective in not only allowing flushing, but remote flushing, as well. All embodiments of the attachment permit the keeping of a pop-up riser stem 60 in an extended position or simply allowing for quick and easy retrieval when the pop-up riser stem is pulled back into the housing by virtue of the spring bias even when connected to the invention. Regardless of where the pop-up riser stem is positioned when the attachment is threadedly connected to it, flushing through the attachment can take place. In addition, it is constructed so that two of the arms could be connected to the upper end of the sprinkler head body or riser stem, depending upon the threaded construction of that body, that is, whether it is of a male threaded construction or a female threaded construction.

FIG. 8 illustrates another embodiment of the invention, attachment A₃, which is provided with an individual duct 86 in each arm, and all of which are in communication with one another. Moreover, each of the arms, such as, for example, the arms 32, 36, 42 and 74, are provided with an internal duct, such that all ducts meet at the center. In addition, each of the ducts 86 communicate with all the arm ends including the two arms 90 which are not used to connect to sprinkler heads. In this case, an externally threaded attachment arrangement could be used, of the type as shown in FIG. 7. Moreover, in order to close off either or both of the open ends 90, the attachment may be provided with one or more commonly available caps 94. These caps may have internally threaded sections 96, for attachment to an externally threaded section 98, on one or both of the arms 42 and 74, as shown therein.

The embodiment of the invention, as shown in FIG. 8, is also highly effective, in that it has an externally threaded hub 102, for attachment to a hose coupling 106 on a hose 108. In this way, water can be directed to a site which may be fairly distant from the site of the sprinkler head. The threaded section 102 would be of a different configuration than the threaded sections for receiving pipe fittings or the like, i.e. 80 and 98.

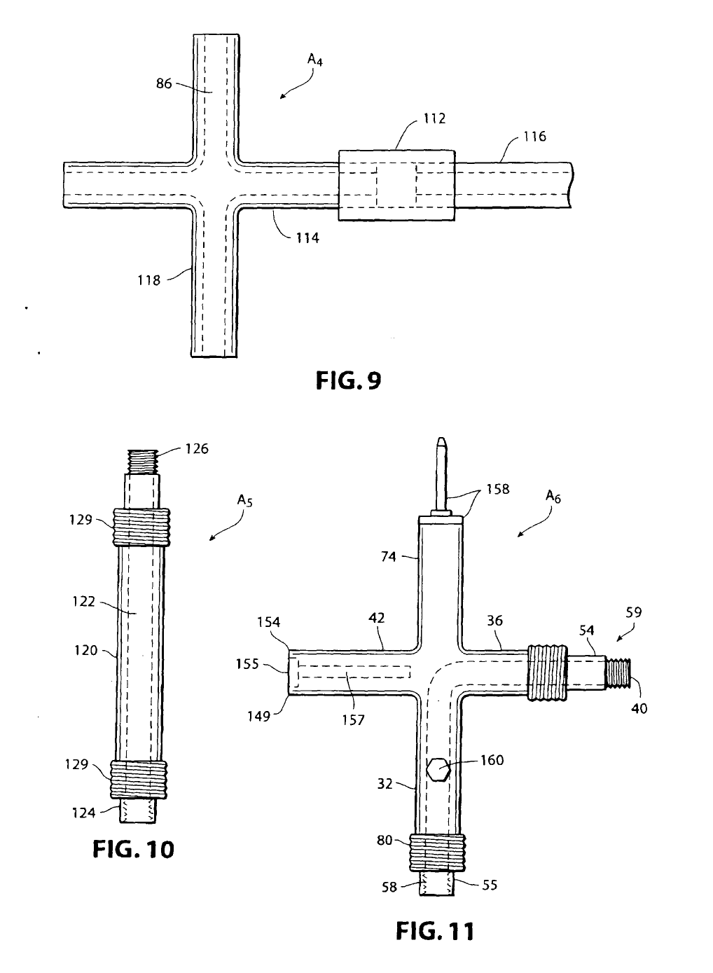

FIG. 9 illustrates an embodiment of the invention in which there is a four-armed attachment A₄, similar to those shown in FIGS. 7 and 8, which can connect to a PVC slip coupling 112, on any one or more of the arms. In this way, a slip coupling may be located on an arm 114 for receiving a pipe 116. The same holds true of all the other arms, i.e. arm 118, located in perpendicular arrangement thereto.

FIGS. 7, 8 and 9 further illustrate the versatility of the attachment of the present invention, and the fact that it can be used not only for cleaning the sprinkler head, but actually supplying a remote source of water which may be needed when no water connection is in reasonable proximity.

FIG. 10 illustrates still a further embodiment of an attachment, As, generally for use with a pop-up sprinkler head. In accordance with the embodiment of the invention as shown in FIG. 10, there is provided a straight pipe section 120, having an internal duct 122 extending therethrough. In this embodiment, one end of the pipe is provided with an internally threaded section 124, and the opposite end is provided with an externally threaded section 126.

In accordance with the construction of the embodiment as shown in FIG. 10, it can be observed that one end, such as, for example, the internally threaded section 124, can be threadedly attached to an externally threaded sprinkler head body 20 (FIG. 3) or pop-up riser stem 60 (FIG. 5). In like manner, the opposite end, which is provided with an externally threaded section 126, can be attached to the internally threaded section of a sprinkler head or of a pop-up riser stem forming part of the sprinkler head. Upon connecting the attachment As, it extends above the surrounding soil level making the pop-up riser stem easily retrievable. In this way, with the connecting of attachment A₅ to a pop-up riser stem, after flushing, the user merely grasps the attachment and pulls the pop-up stem forming part of a pop-up sprinkler head, upwardly of the body of the sprinkler head in order to replace the nozzle of the sprinkler.

After attachment A₅ is connected to the pop-up riser stem of the sprinkler head, water can be turned on under pressure, allowing the flushing water to pass through the body of the sprinkler head, and wash out any debris which may have accumulated within the sprinkler head. The water is directed upwardly and out of the sprinkler head body 20. This water, which may already contain entrained dirt particles, will not be allowed to enter back into the body of the sprinkler head, due to the fact that the attachment is secured thereto and the upper end is sufficiently above the surrounding soil level, even if the pop up stem 60 has retracted completely into the housing as shown in FIG. 6.

After the foul water has been removed and flushed therefrom, the water can be turned off and the top of the sprinkler head, e.g., the nozzle, re-secured to the pop-up riser stem 60.

The attachment A₅ can be constructed at both ends 129 with either exterior male pipe threads or accommodate PVC slip fittings. In this way, the end 124 or 126 which is not connected to the pop-up riser stem 60, can provide for attachment of another fitting or a hose, or the like. In this way, the attachment of FIG. 10, although quite simple, is still quite versatile.

FIG. 11 illustrates still a further and preferred embodiment of the invention, A₆, which includes a somewhat similar arm arrangement as illustrated in FIG. 7. In this case, there is an internally threaded section 58 on an arm 32 for attachment to an externally threaded stationary sprinkler head body 20 or pop-up riser stem 60. The arm 32 is similar to the previously described arm 32, but is of longer length, as hereinafter described.

The arm 36 similarly includes an externally threaded section 59, for connection to an internally threaded sprinkler head body 20 or pop-up riser stem 60. The arm 36 preferably is of the same length as the previously described arm 36. Further, an end 149 of the arm 42 is sized to receive a permanently fixed plug 154 with a hole 155 therein allowing for storage within an internal cavity 157 of a tool, such as an Allen wrench, which the longest part thereof is inserted through the hole and holstered therein when not in use. In this embodiment, the tool, not shown, could be removed from its storage cavity within the arm 42 and used to control a valve 160 located in one of the arms, such as the arm 32. For this reason, the arm 32 has a length greater than the others of the arms, although for balancing purposes, it may be preferable to increase the length of parallel arm 74 to equal that of arm 32.

The valve 160 is a relatively small valve designed to control the flow of fluid through the attachment in order to control the water being flushed during cleaning or servicing of a sprinkler head. The valve 160 is patterned after and operates similar to this applicant's U.S. Pat. No. 6,568,608.

In the embodiment as shown in FIG. 11, there is also provided a tool head 158 at the end of arm 74 having a tool that could be used with sprinkler systems or any other type of system. The preferred type of tool would be a small screwdriver sized to operate the small flow-adjusting screw found in the top portion of the nozzles manufactured by virtually every producer of plastic sprinkler heads worldwide. It would be preferable that the tool head 158 be permanently affixed to the end of arm 74 in a similar manner as the plug 154 at arm 42.

Although the four-arm cross design is the embodiment most often illustrated in the accompanying drawings, it is noted herein that the attachment could easily be constructed as a three-arm attachment and in so doing would essentially provide all the benefits ascribed to the four-arm attachment.

Thus, there has been illustrated and described a unique and novel attachment for flushing water and debris from a sprinkler head, and which thereby fulfills all of the objects and advantages which have been sought. It should be understood that many changes, modifications, variations and other uses and applications will become apparent to those skilled in the art after considering the specification and the accompanying drawings. Therefore, any and all such changes, modifications, variations and other uses and applications which do not depart from the spirit and scope of the invention are deemed to be covered by the invention.

1. An attachment to a spray-type water sprinkler head which has a portion thereof generally at the same level as or above a ground surface for allowing of flushing of the head without saturating the immediate area around the sprinkler head, said attachment comprising:
a) a body having a first arm with a duct extending therethrough to direct water and any debris in a generally upward direction to thereby allow any flushing of the head;
b) a second arm having a duct extending therethrough to allow for redirection of the water and any debris carried therewith to a location away from the site of the sprinkler head; and
c) an outwardly extending third arm which can be engaged by a user of the attachment to facilitate connection and disconnection of the attachment to the sprinkler head.

2. The attachment for a sprinkler head of claim 1 further characterized in that said second arm directs water and any debris carried therewith in a direction angularly located to the direction of water and debris in the duct of the first arm.

3. The attachment for a sprinkler head of claim 1 further characterized in that said second arm directs water and any debris carried therewith in a direction of approximately 90° with respect to the duct in said first arm.

4. The attachment for a sprinkler head of claim 1 further characterized in that said first arm and said second arm are integral with one another and said first and second ducts generally have the same diameter and are in fluid communication with one another.

5. The attachment for a sprinkler head of claim 4 further characterized in that said third arm is also integral to said first and second arms and extends in a direction generally parallel to one of said first and second arms and generally perpendicular to said first and second arms.

6. The attachment for a sprinkler head of claim 1 further characterized in that a fourth arm is also connected to said first, second and third arms also in a direction parallel to one of said first and second arms and generally perpendicular to the other of said first and second arms.

7. The attachment for a sprinkler head of claim 4 further characterized in that said third arm is also integral to said first and second arms and extends in a direction generally parallel to one of said first and second arms and generally perpendicular to said first and second arms said third arm also having a duct in fluid communication with the ducts in said first and second arms and which allows for a flushing of water therethrough when one of said first or second arms does not allow for a flushing of water and any debris therethrough.

8. The attachment for a sprinkler head of claim 7 further characterized in that a fourth arm is also connected to said first, second and third arms also in a direction parallel to one of said first and second arms and generally perpendicular to the other of said first and second arms, and said third arm is located at a direction generally parallel to one of said first and second arms and generally perpendicular to the other of said first and second arms and said fourth arm is located in a direction generally parallel to one of said second and third arms and generally perpendicular to the other of said second and third arms.

9. The attachment for a sprinkler head of claim 8 further characterized in that said fourth arm has a duct extending therethrough.

10. An attachment for connection and disconnection to a limited area spray-type water sprinkler head to allow flushing of the head, said attachment comprising:
a) first and second arms which are angularly located with respect to one another to divert water being flushed through the sprinkler head;
b) a third arm extending angularly with respect to said first and second arms and also being capable of directing water being flushed through the sprinkler head; and
c) threaded connection means on certain of said arms for direct connection to a threaded section of an upper end of said sprinkler head.

11. The attachment for connection and disconnection to a water sprinkler head of claim 10 further characterized in that said arms have the shape of a cross.

12. The attachment for connection and disconnection to a water sprinkler head of claim 10 further characterized in that said threaded connection means on said certain of said arms comprises a female threaded section on said attachment and a male threaded section on said sprinkler head attachment.

13. The attachment for connection and disconnection to a water sprinkler head of claim 10 further characterized in that said threaded connection means on said certain of said arms comprises a male threaded section on said attachment and a female threaded section on said sprinkler head attachment.

14. The attachment for connection and disconnection to a water sprinkler head of claim 10 further characterized in that said certain of said arms comprises a male threaded section on said attachment and a female threaded section on said sprinkler head attachment.

15. The attachment for connection and disconnection to a water sprinkler head of claim 10 further characterized in that said threaded connection means comprises a female connection means on one of said arms and a male connection means on another of said arms.

16. A method for directing water from a sprinkler head body in a spray-type non-rotor and non-impact sprinkler system along with any debris therein concurring with being flushed through a sprinkler head and away from the site of the sprinkler head, said method comprising:
a) directing flushing water under pressure through a sprinkler head body;
b) connecting an attachment to the sprinkler head body or a riser therefor;
c) directing the water flushing from the sprinkler head body through an upwardly arranged pipe on said attachment; and
d) thereafter directing the flushing water through an angularly arranged pipe on said attachment to thereby direct the water away from the site of the sprinkler head.

17. The method for directing water from a sprinkler head body of claim 16 further characterized in that said method comprises directing the flushing water away from the site of the sprinkler head at an angle of about 90° with respect to the vertically arranged pipe.

18. The method for directing water from a sprinkler head body of claim 16 further characterized in that said method comprises first removing an insert in the sprinkler head and thereafter attaching to said sprinkler head body a device comprising the upwardly arranged pipe and the angularly arranged pipe.

19. A device for holding a pop-up stem of a pop-up spray-type sprinkler head in a partially extended position to allow for servicing or flushing of a body of the sprinkler head, said device comprising:
a) a tube having an inner duct extending therethrough from end to end of the tube and being arranged for removable attachment to an upper end of a pop-up stem of said sprinkler head so that the tube is generally vertically arranged;
b) a lower end of said tube sized to engage an upper end of said sprinkler head when attached to the pop-up riser stem;
c) first threaded connection means at said tube for mating threaded connection to the upper end of said pop-up riser stem of said sprinkler head such that the tube is generally vertically arranged and with said duct allowing for flow of flushing water therethrough; and
d) second threaded connection means at said tube and also allowing for attachment to a different type of threaded connection on another type of pop-up stem.

20. The device for use with a pop-up sprinkler head of claim 19 further characterized in that said device also has another tube connected to said first named tube and extending angularly away from said first tube.

21. The device for use with a pop-up sprinkler head of claim 19 further characterized in that said threaded connection means comprises a first connection section and a spaced apart second connection section for attachment to a threaded section on said pop-up shaft different from a threaded section on said pop-up shaft than the first connection section would be attached to.

22. The device for use with a pop-up sprinkler head of claim 19 further characterized in that said lower end is sized for abutting engagement with an upper end of said sprinkler head body.

23. The device for use with the pop-up sprinkler head of claim 21 further characterized in that said first connection section is an internally threaded section and said second connection section is an externally threaded section.

24. The device for use with the pop-up sprinkler of claim 19 further characterized in that one of said threaded connection means comprises a threaded section sized to fit a conventional garden hose.
